(19) United States
(12) Patent Application Publication
(10) Pub. No.: US 2003/0116962 A1
(43) Pub. Date: Jun. 26, 2003

(54) Adaptor for forming a branch in a conduit

(76) Inventors: Brian Roy Magennis, Kempton Park (ZA); Alan Stanley Donaldson, Johannesburg (ZA); Albert Lampen, Pretoria (ZA)

Correspondence Address: FISH & NEAVE, 1251 AVENUE OF THE AMERICAS, 50TH FLOOR, NEW YORK, NY, 10020-1105, US

(21) Appl. No.: 10/310,072

(22) Filed: Dec. 4, 2002

(30) Foreign Application Priority Data
Dec. 5, 2001 (ZA) 2001/10016

(51) Int. Cl. F16L 41/00

(52) U.S. Cl. 285/133.21; 285/145.4; 138/155; 138/177

(57) ABSTRACT

An adaptor for forming a branch in a conduit is shaped and dimensioned to slide onto a cylindrical conduit. The adaptor includes a collar having an outer generally circumferentially extending wall, end walls and a cylindrical passage extending between the end walls. The passage has an inner wall and an opening at each end, and spaced resiliently deformable sealing means adjacent each opening. The sealing means is positioned to provide a seal between the collar and the cylindrical conduit when the adaptor is slidingly engaged with the cylindrical conduit. The collar includes at least one fluid flow passage extending between the outer wall and the inner wall.

THIS INVENTION relates to an adaptor, to a method of forming a branch in a conduit, to a kit for assembling a fogging or spraying installation and to a fogging or spraying installation.

In fogging installations, fogs are produced by pumping water under high pressure through high pressure fog nozzles. These have apertures which typically range from about 0,15 mm to 0,5 mm. Fogs are used in a variety of different ways. For example, fogs are used to cool and humidify the air either indoors or outdoors, for example in greenhouses and wine stores or in any other area in which a cooling effect is required. The small (approximately 5-10 μ) water droplets of the fog quickly evaporate and thereby cool and humidify the air. The cooling effect of the fog can be enhanced by using an axial flow fan in combination with a fogging installation to blow the fog through an area to be cooled. The fan enhances evaporation and increases the cooling effect. Fogs can also be used to suppress dust which is produced, for example, in mining, rock crushing and similar processes. Fogs are also used in odour control for example in manufacturing, industrial and waste handling processes by mixing the water used to produce the fog with any of a range of odour neutralizing substances. Fogs can also be used to produce special effects by strategically locating fogging nozzles for example around ponds and water features, in theme parks and the like. Fogs are used to create special effects in motion pictures.

A problem associated with the installation of fogging systems is to efficiently and cost-effectively locate fogging nozzles at predetermined positions along a length of conduit or pipe. A variety of prior art methods have been used to place “tees” at predetermined positions on a manifold or conduit. Off the shelf compression or threaded T-piece fittings generally require cutting the conduit before attaching the fitting and attaching these is both expensive and labour intensive.

Alternatively, a hole can be formed in the conduit at the required position and a riser attached to the conduit over the opening by soldering, silver soldering or arc welding. A spray or fogging nozzle is then screw-threadedly attached to the riser. This procedure is also labour intensive and extremely time consuming. A further problem associated with these procedures is that, once a riser has been secured in place, it cannot easily, or at all, be moved to another position. A further problem associated particularly with the latter procedure is that about one in ten welded or soldered seals will fail. The adaptor and the method of this invention are intended to address this problem.

According to a first aspect of the invention, there is provided an adaptor for forming a branch in a conduit, the adaptor being shaped and dimensioned to slide onto a cylindrical conduit and including a collar having an outer generally circumferentially extending wall, end walls and a cylindrical passage extending between the end walls, the passage having an inner wall and an opening at each end, and

spaced resiliently deformable sealing means adjacent each opening, the sealing means being positioned to provide a seal between the collar and the cylindrical conduit when the adaptor is slidingly engaged with the cylindrical conduit.

The collar may include at least one fluid flow passage extending between the outer wall and the inner wall. The fluid flow passage may be a threaded opening. The inner wall of the passage may include a pair of circumferentially extending spaced grooves and the resiliently deformable sealing means may be in the form of O-rings provided in the grooves.

The collar may further include an annular recess in the inner wall between the sealing means which, in use, provides a flow path between the opening in the conduit and the fluid flow passage through the collar, whether or not the fluid flow passage is in register with, or aligned with, the opening in the conduit. This recess will also provide a larger volume for water flowing from the conduit through the fluid flow passage as is described in further detail below. The fluid flow passage may be connected to a secondary conduit. Preferably, the fluid flow passage will be connected to a spray nozzle or atomiser (fogging) nozzle.

The collar may be made from brass, bronze, stainless steel, a plastics material, or the like, depending on the type of fluid flowing through the conduit and fluid operating pressures. Similarly, the material from which the O-ring is manufactured can be selected to suit different fluids. The collar will typically be used within the pressure range of 0-200 Bar. The wall thickness of the collar will accordingly be adjusted depending on operating pressures.

The collar may thus be made from a material selected from brass, bronze, stainless steel and plastics materials.

The generally circumferentially extending outer wall of the collar may be a circular wall and the passage will typically be circular and symmetrically arranged with respect to the outer wall. However, the outer wall may, instead, be polygonal for example having 4, 5, 6 or more sides.

In other embodiments of the invention, the passage may be offset so that the distance between the inner passage wall and the outer wall of the collar is smaller on one side of the adaptor and greater on the other. The wall of the adaptor will thus be thicker on one side and thinner on the other. The fluid flow passage will then preferably extend between the outer wall and inner wall on the thicker side of the adaptor.

The adaptor of the invention is particularly useful in the assembly of fogging installations for evaporative cooling and chilling, humidity control, dust suppression and control and odour control. It is also useful in the assembly of fogging or spraying applications in greenhouses, nurseries, hot houses and the like.

According to a second aspect of the invention, there is provided a method of forming a branch in a conduit, the method including the steps of

slidingly locating a collar over an opening through a wall of a conduit;

providing a seal between the collar and the conduit on either side of the opening with resiliently deformable sealing means; and

forming at least one fluid flow passage to extend through the collar so that a fluid flow path is formed between the opening in the wall of the conduit and the flow passage.

The fluid flow passage may be formed before or after the collar is slidingly located over the opening.

Instead, the method may include the steps of

slidingly locating a collar on a conduit having a conduit wall;

providing a pair of spaced apart seals between the collar and the conduit wall with resiliently deformable sealing means; and

forming at least one fluid flow passage to extend through the collar and the conduit wall so that a fluid flow path is formed between the inside of the conduit and the fluid flow passage.

The method may thus include forming the opening in the collar and/or the conduit either before or after slidingly locating the collar on the conduit.

The collar may have a cylindrical passage with opposed circular collar openings and the conduit may be a cylindrical conduit and the seal may be provided adjacent the collar openings. The method may include the step of connecting one of a spray nozzle, a fogging nozzle or a secondary conduit to the or each fluid flow passage. The resiliently deformable sealing means may be provided by O-rings.

Connecting the fogging nozzle, spray nozzle or secondary conduit to the or each fluid flow passage may include forming a thread in the or each fluid flow passage and screw-threadedly attaching the fogging nozzle, spray nozzle or secondary conduit to the passage.

The invention extends to an adaptor for forming a branch in a conduit, the adaptor being shaped and dimensioned to slide onto a cylindrical conduit and including a collar having an outer generally circumferentially extending wall, end walls and a cylindrical passage extending between the end walls, the passage having an inner wall and an opening at each end, and

spaced receiving formations adjacent each opening which are shaped and dimensioned to receive resiliently deformable sealing means.

The receiving formations may be in the form of a pair of grooves for receiving resiliently deformable sealing means in the form of O-rings.

According to another aspect of the invention, there is provided a kit for use in assembling a fogging or spraying installation such as a spray irrigation installation, the kit including a plurality of adaptors as hereinbefore described and a plurality of nozzles. The kit may include a plurality of O-rings.

The invention extends to a fogging or spraying installation which includes at least one water conduit, a plurality of adaptors as hereinbefore described secured to the or each conduit and a plurality of fogging or spraying nozzles attached to the adaptors.

In use, the collar, generally with the fluid flow passage, or branch opening, already drilled and threaded is slid over an outlet opening which has been drilled in a conduit and a nozzle is screwed into the branch opening and water allowed to flow through the pipe. The flow of water through the pipe and into the collar results in increased pressure in the annular recess forcing the O-rings outwards against the circumferentially spaced grooves and against the conduit thus effecting an effective seal, whilst the water exits via the nozzle in the form of a fog or spray. A collar of this type is commonly referred to as a riser.

The adaptor or riser of the invention is not limited to use with fogging installations or spray irrigation installations but can be used to form branches in conduits of varying sizes carrying different fluids or liquids such as organic or inorganic liquids, solutions and the like and can, further, be used with conduits through which compressed gas is piped. The adaptor can be used to form branches in pipes having large diameters, for example 10-12 inches. The adaptor of the invention can also be used to form an inlet for feeding a liquid into a conduit, for example a conduit through which a liquid is already flowing.

Further features of the invention will become apparent from the following description, by way of example, with reference to the accompanying drawings, in which

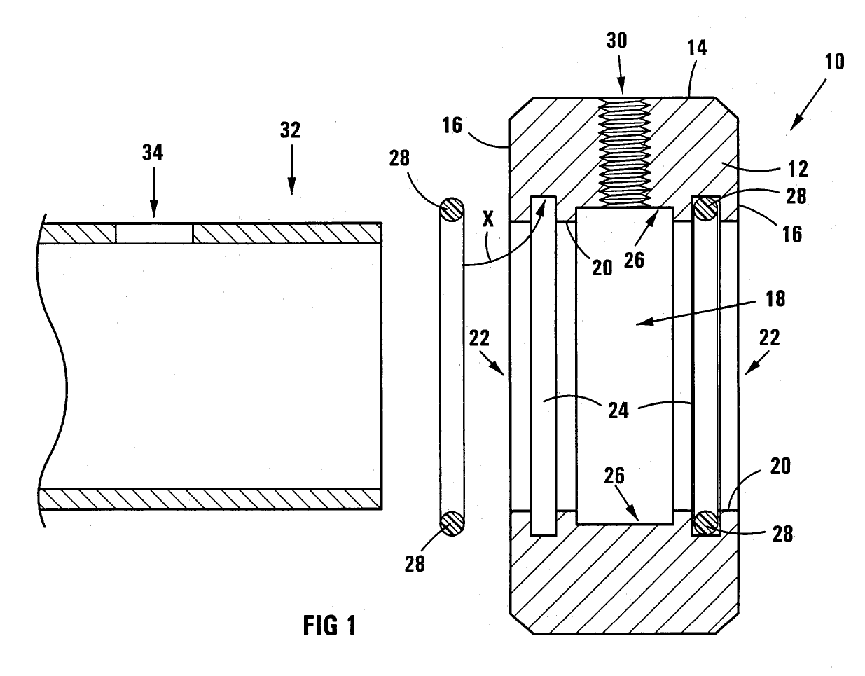

FIG. 1 is a diagrammatic drawing, showing a schematic cross-sectional elevation of an adaptor or riser in accordance with the invention and a part of a conduit; and

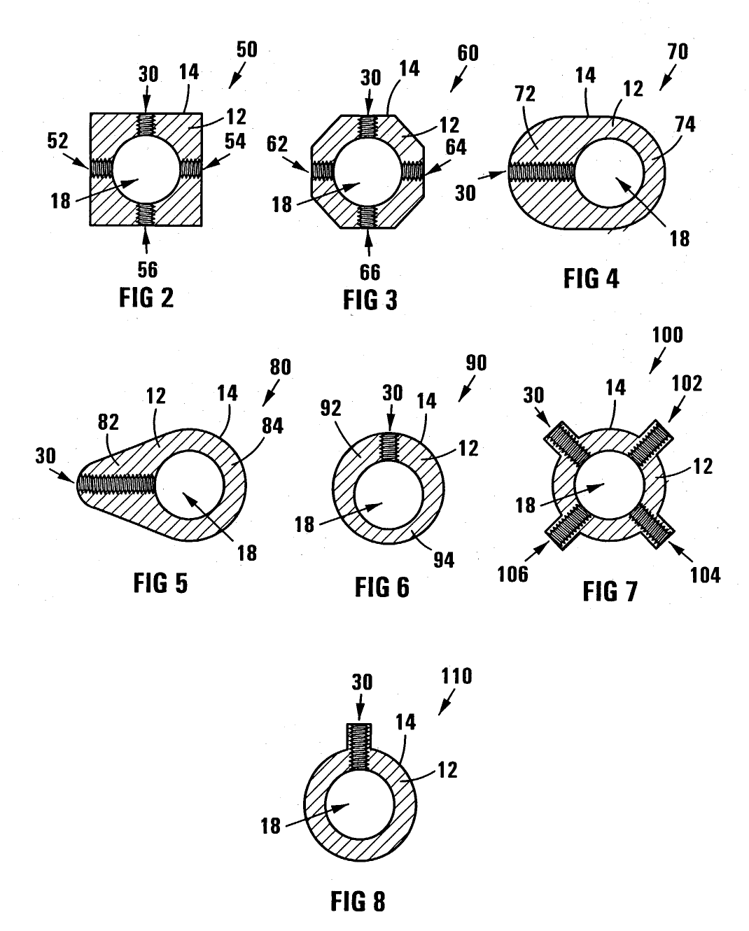

FIGS. 2-8 schematically show seven other embodiments of adaptors in accordance with the invention.

Referring to FIG. 1, the adaptor 10 comprises an annular body 12 with an outer circumferentially extending surface 14 and opposed end faces 16.

A passage 18 with an inner surface 20 extends between opposed openings 22 in the end faces 16. A groove 24 is provided in the inner surface 20 of the passage 18 adjacent each opening 22 and a further groove, or annular recess 26 is provided midway between the openings 22 so that the inner surface 20 has a stepped profile.

An O-ring 28 is located in each groove 24. A threaded fluid flow passage outlet or outlet opening 30 extends from the groove 26 to the outer surface 14.

In the embodiment depicted in the drawing, the body 12 has a diameter of 37 mm and a thickness of 17 mm. The passage 18 has a diameter of 20,1 mm. The grooves 24 are spaced 1,5 mm from the openings 22 and have a depth of 1.7 mm and a width of 2 mm. The recess 26 has a depth of between 1.4 and 1.9 mm and a width of 8 mm.

The adaptor 10 is shown next to a section of a conduit 32. The conduit 32 has an outlet opening 34. The conduit 32 has an outer diameter of 20 mm and, in different embodiments of the invention, the outlet opening 34 ranges from about 3-6 mm in diameter.

The O-rings 28 are 2 mm thick and have an outer diameter of 23,5 mm and an inner diameter of 20,5-21 mm.

In use, the O-rings 28 are inserted into the grooves 24 as indicated by the arrow indicated by letter X. The adaptor 10 is then slidingly located over the opening 34 of the conduit 32. A secondary conduit (not shown), for example a fogging nozzle, is then screwed onto the threaded hole 30. A plurality of adaptors 10 will typically be slidingly located at different positions over a plurality of openings 34 in the conduit 32, with the end of the pipe connected to a water supply. Instead, the adaptors 10 may be located on the conduit 32 and the openings 34 formed at a latter stage prior to use, for example by drilling.

When the water supply is turned on, water flows through the conduit 32 into the collar 12, a pressure build-up takes place in the recess 26 forcing the O-rings 28 to expand outwardly against the walls of the grooves 24 and against the conduit 32 thus effecting an effective seal, whilst the water exits via the fogging nozzle.

It will be appreciated that the threaded hole 30 in the adaptor 10 and the opening 34 in the conduit 32 may be formed after the adaptor 10 has been slidingly located on the conduit 32.

Referring to FIGS. 2 to 8, reference numerals 50, 60, 70, 80, 90, 100 and 110 generally indicate seven other embodiments of adaptors in accordance with the invention. The adaptors 50-110 broadly resemble the adaptor 10 and the same reference numerals have been used to indicate the same or similar features of the adaptors 50-110 and 10.

The adaptor 50 differs from the adaptor 10 in that it has a square profile in end view whilst the adaptor 10 has a circular profile in end view. The adaptor 50 accordingly resembles a nut. The adaptor 50, further, has three additional outlet openings 52, 54, 56 in addition to the opening 30 which are symmetrically arranged opposite the opening 30 (opening 56) and at right angles to the opening 30 (openings 52 and 54).

The adaptor 60 closely resembles the adaptor 50 in that it also has three additional outlet openings 62, 64, 66 corresponding to the openings 52, 54, 56 of the adaptor 50. It differs from the adaptor 50 in that it has an octagonal profile in end view.

In the adaptors 70, 80 and 90 the passages 18 are off-set in the body 12 of each adaptor so that the wall on one side of the passage is thicker than that on the other. The outer surface 14 of the adaptor 70 is generally oval in end view. The outer surface 14 of the adaptor 80 is generally tear-dropped shaped in end view and the outer surface 14 of the adaptor 90 is generally circular in end view. Because the passages 18 of the adaptors 70, 80 and 90 are off-set the adaptor 70 has a thicker side 72 and a thinner side 74, the adaptor 80 has a thicker side 82 and a thinner side 84 and the adaptor 90 has a thicker side 92 and a thinner side 94. The openings 30 of the adaptors 70, 80 and 90 are formed in the thicker sides 72, 82 and 92. In this way, sufficient material is available to form a threaded opening of about 4 mm in length whilst the thinner side is nevertheless thick enough to withstand the pressures at which the adaptors typically operate.

The adaptor 100 differs from the adaptor 10 in that four additional openings 102, 104 and 106 are provided in addition to the opening 30, the opening 104 being opposite the opening 30 and the openings 102, 106 being arranged at right angles to the opening 30. The openings 30, 102, 104 and 106 are provided in raised portions of the body 12 of the adaptor 100. In this way, again, sufficient material is provided to form the threaded openings whilst the wall thickness of the body 12 of the adaptor is thinner but sufficient to withstand typical operating pressures.

The adaptor 110 differs from the adaptor 100 only in that the openings 102, 104, 106 and the corresponding raised portions of the body 12 are absent.

Those embodiments of the invention in which the passage 18 is off-set in the body 12 of the adaptor result in a saving in material when the adaptors are manufactured because only that part of the wall in which the threaded opening is formed is thick.

The invention as described and illustrated is especially useful in high pressure fogging systems. It is an advantage of the invention illustrated that the adaptor according to the invention is easy to use, introduces more flexibility to locating nozzles or forming branches in conduits 32 as the threaded holes for attaching the nozzles may be made before or after the collar 12 has been slid onto the conduit 32. Use of the adaptor 10 according to the invention results in zero failure rates of nozzles on pressurisation, in high pressure fogging systems and applications. Furthermore, the adaptor 10 may be positioned over any pre-prepared openings 34 in the conduits with instant sealing on pressurisation. A further advantage of the invention as described and illustrated is that should a nozzle position be incorrect, a blank adaptor without the threaded hole 30 may be positioned over the opening 34 and a threaded adaptor 10 slidingly located over a correct opening 34 with instant sealing on pressurisation. The invention allows the entire length of a pipe or conduit to be used without it having to be cut as in the case of prior art adaptors.

It is a further advantage of the invention illustrated that the openings in the pipe and adaptor do not have to be in register. The groove 26 provides a flow path to the branch opening 30 irrespective of the orientation of the adaptor 10 relative to the pipe 32. This also allows adjustablility of the nozzle position as the adaptor can be rotated through 360° on the pipe. The applicant has also found that assembling an irrigation installation using the adaptors and nozzles of the invention results in a very substantial time saving and hence a substantial cost saving. Openings can be formed in the conduit in predetermined positions quickly and easily simply using a hacksaw blade. The conduit is then lubricated, for example with soapy water, and the adaptors are slid into position. The nozzles are screwed into the adaptors either before or after the adaptors are slid onto the conduit. As water flows into the system, the resulting pressurisation causes the O-rings to seal the adaptors to the conduit. The conduit can then be positioned at any angle from vertical to horizontal without any danger of the adaptors sliding along the conduit.

It is a further advantage of the invention illustrated that the adaptors of the invention in which the passage is offset, so that the adaptor has a thicker side and an opposite thinner side, results in a saving in material. In order to screw threadedly attach the nozzles to the adaptors, a minimum threaded length is required. This is a typically about 3-4 mm. However, the thickness of material required to withstand the pressure at which a typical irrigation system operates requires a substantially thinner wall, typically about 2 mm. By offsetting the passage through the adaptor, sufficient material is provided on one side of the passage for forming the screw threaded passage for the nozzle whilst the opposite thinner side is thick enough to withstand the pressure at which the irrigation system operates. In this way, less material is used to manufacture the adaptors.

This results in a substantial cost saving.

It is a further advantage of the invention illustrated that the adaptor or collar can be rotated on the conduit even while under pressure. This allows a rotation mechanism to be connected to the adaptor, for example, by way of a ratchet assembly which is engageable with a mating ratchet formation on the adaptor or a motor driven drive belt which is engaged with the adaptor.

It is a further very important feature of the invention that the adaptors and nozzles of the invention allow a fogging or spraying assembly to be assembled approximately ten times faster than by conventional methods for example involving soldering or welding the adaptors of the prior art to the conduit or fitting T-piece fittings to the conduit. This results in a substantial saving on labour costs.

An advantage of the use of fogs is that they do not in general cause wetting of objects which are exposed to the fog in an area which is humidified or cooled e.g. plants in a greenhouse, machines or the like in factories etc.

Conventional seals formed using solder, silver solder or welds often fail as a result of repeated expansion and contraction of the pipe as fluid flow is turned on and turned off. This expansion and contraction can cause cracks to develop or can affect the integrity of the seal between the weld and the pipe and can eventually cause the seal to fail. In contrast, the Applicant has found that the failure rate of seals using the adaptors of the invention is zero despite very extensive and repeated turning on and turning off of fluid flow and up to a pressure of as much as 200 bar, the only failures experienced being as a result of prior damage to the O-ring by a burr on the conduit. As long as the collar/adaptor and the O-rings used are sized correctly, the installation will last for hundreds of thousands of pressurising cycles and the Applicant estimates that the installation will withstand a million or more pressurising cycles without failing. The use of O-rings as the sealing means can also prevent problems associated with sealing pipes which may not be perfectly circular in cross-section due to manufacturing flaws by taking up discrepancies in the pipe shape. The adaptors and nozzles of the invention have been shown in practice to be superior to and far more cost-effective than prior art systems known to the Applicant.

1. An adaptor for forming a branch in a conduit, the adaptor being shaped and dimensioned to slide onto a cylindrical conduit and including a collar having an outer generally circumferentially extending wall, end walls and a cylindrical passage extending between the end walls, the passage having an inner wall and an opening at each end, and
spaced resiliently deformable sealing means adjacent each opening,-the sealing means being positioned to provide a seal between the collar and the cylindrical conduit when the adaptor is slidingly engaged with the cylindrical conduit.

2. An adaptor as claimed in claim 1, in which the collar includes at least one fluid flow passage extending between the outer wall and the inner wall.

3. An adaptor as claimed in claim 2 in which the fluid flow passage is a threaded opening.

4. An adaptor as claimed in claim 1, in which the inner wall of the passage includes a pair of circumferentially extending spaced grooves and in which the resiliently deformable sealing means is in the form of O-rings provided in the grooves.

5. An adaptor as claimed in claim 1, in which the inner wall of the passage has an annular recess between the sealing means.

6. An adaptor as claimed in claim 2, in which the fluid flow passage is connected to a secondary conduit.

7. An adaptor as claimed in claim 2, in which the fluid flow passage is connected to a fogging or spray nozzle.

8. An adaptor as claimed in claim 1, in which the collar is made from a material selected from brass, bronze, stainless steel and plastics materials.

9. A method of forming a branch in a conduit, the method including the steps of
slidingly locating a collar over an opening through a wall of a conduit;
providing a seal between the collar and the conduit on either side of the opening with resiliently deformable sealing means; and
forming at least one fluid flow passage to extend through the collar so that a fluid flow path is formed between the opening in the wall of the conduit and the flow passage.

10. A method as claimed in claim 9, in which the collar has a cylindrical passage with opposed circular collar openings and the conduit is a cylindrical conduit and the seal is provided adjacent the collar openings.

11. A method as claimed in claim 9, which includes the step of connecting one of a spray nozzle, a fogging nozzle or a secondary conduit to the or each fluid flow passage.

12. A method as claimed in claim 9, in which the resiliently deformable sealing means is provided by O-rings.

13. A method as claimed in claim 11, in which connecting the spray nozzle, fogging nozzle or secondary conduit includes forming a thread in the or each fluid flow passage and screw-threadedly attaching the spray nozzle, fogging nozzle or secondary conduit to the passage.

14. A method of forming a branch in a conduit, the method including the steps of
slidingly locating a collar on a conduit having a conduit wall;
providing a pair of spaced apart seals between the collar and the conduit wall with resiliently deformable sealing means; and
forming at least one fluid flow passage to extend through the collar and the conduit wall so that a fluid flow path is formed between the inside of the conduit and the fluid flow passage.

15. A method as claimed in claim 14, in which the collar has a cylindrical passage with opposed circular collar openings and the conduit is a cylindrical conduit and the seal is provided adjacent the collar openings.

16. A method as claimed in claim 15, which includes the step of connecting one of a spray nozzle, a fogging nozzle or a secondary conduit to the or each fluid flow passage.

17. A method as claimed in claim 14, in which the resiliently deformable sealing means is provided by O-rings.

18. A method as claimed in claim 16, in which connecting the spray nozzle, fogging nozzle or secondary conduit includes forming a thread in the or each fluid flow passage and screw-threadedly attaching the spray nozzle, fogging nozzle or secondary conduit to the passage.

19. An adaptor for forming a branch in a conduit, the adaptor being shaped and dimensioned to slide onto a cylindrical conduit and including a collar having an outer generally circumferentially extending wall, end walls and a cylindrical passage extending between the end walls, the passage having an inner wall and an opening at each end, and
spaced receiving formations adjacent each opening which are shaped and dimensioned to receive resiliently deformable sealing means.

20. An adaptor as claimed in claim 19 in which the receiving formations are in the form of a pair of grooves for receiving resiliently deformable sealing means in the form of O-rings.

21. A kit for use in assembling a fogging installation or a spraying installation, the kit including a plurality of adaptors as claimed in claim 1, and a plurality of nozzles.

22. A kit for use in assembling a fogging installation or a spraying installation, the kit including a plurality of adaptors as claimed in claim 19, a plurality of nozzles and a plurality of O-rings.

23. A kit as claimed in claim 21, which includes at least one length of conduit.

24. A kit as claimed in claim 22, which includes at least one length of conduit.

25. A fogging or spraying installation which includes at least one water conduit a plurality of adaptors as claimed in claim 1, secured to the or each conduit and a plurality of nozzles secured to the adaptors.
